(19) United States
(12) Patent Application Publication
(10) Pub. No.: US 2025/0356175 A1
(43) Pub. Date: Nov. 20, 2025

(54) DATA COMPRESSION AND RECONSTRUCTION USING SPARSE META-LEARNED NEURAL NETWORKS

(71) Applicant: DeepMind Technologies Limited, London (GB)

(72) Inventor: Jonathan Schwarz, London (GB)

(21) Appl. No.: 18/862,782

(22) PCT Filed: May 3, 2023
(86) PCT No.: PCT/EP2023/061711

§ 371 Date: Nov. 4, 2024

Related U.S. Application Data
(60) Provisional application No. 63/338,018, filed on May 3, 2022.

(51) Int. Cl. G06N 3/0495; G06N 3/08

(52) U.S. Cl. CPC G06N 3/0495; G06N 3/08

(57) ABSTRACT

Methods, systems, and apparatus, including computer programs encoded on computer storage media, for compressing and decompressing data signals using sparse, meta-learned neural networks.

### CROSS-REFERENCE TO RELATED APPLICATION

This application claims priority to U.S. Provisional Application No. 63/338,018, filed on May 3, 2022. The disclosure of the prior application is considered part of and is incorporated by reference in the disclosure of this application.

### BACKGROUND

This specification relates to compressing and reconstructing input signals using machine learning models.

As one example, neural networks are machine learning models that employ one or more layers of nonlinear units to predict an output for a received input. Some neural networks include one or more hidden layers in addition to an output layer. The output of each hidden layer is used as input to another layer in the network, e.g., the next hidden layer or the output layer. Each layer of the network generates an output from a received input in accordance with current values of a respective set of weights.

### SUMMARY

This specification describes a system implemented as computer programs on one or more computers that compresses an input signal using a data reconstruction neural network having network parameters.

In particular, the system uses the input signal to determine, for a subset of the network parameters, updates to shared values of the network parameters.

The system then generates a compressed representation of the input signal that identifies the respective updates for the subset of network parameters.

The system or another system can use the data reconstruction neural network to decompress the input signal by determining updated values of the network parameters using the shared values and the compressed representation and reconstructing the input signal using updated values.

In one aspect, a method includes maintaining data specifying shared values for network parameters of a data reconstruction neural network, wherein the data reconstruction neural network is configured to receive an input specifying a coordinate from a coordinate space of an input data signal and to process the input in accordance with the network parameters to generate as output one or more predicted values of the input data signal at the specified coordinate; receiving a new input signal comprising one or more respective new values at each of a plurality of new coordinates; determining a respective update for each of a subset of the network parameters, comprising: at each of one or more inner iterations: determining one or more sets of current values for the network parameters of the data reconstruction neural network, comprising, for each set of current values: determining, in accordance with a set of distribution parameters, a respective gate value for each network parameter in the subset that specifies whether the respective update for the subset is set to zero; determining the set of current values by: for any network parameters not in the subset, setting the current value based on the shared value for the network parameter; for any network parameters in the subset for which the respective gate value specifies that the respective update for the subset is set to zero, setting the current value based on the shared value for the network parameter; and for any network parameters in the subset for which the respective gate value specifies that the respective update for the subset is not set to zero, setting the current value based on the shared value for the network parameter and the respective update for the network parameter; for each of the one or more sets of current values of the network parameters: for each of the new coordinates, processing an input specifying the new coordinate using the data reconstruction neural network and in accordance with the set of current values of the network parameters to generate one or more current predicted values for the new coordinate; determining a respective gradient with respect to each of the respective updates for the network parameters in the subset and the distribution parameters of an inner loss function that, for each set of current values, includes (i) a reconstruction quality term that measures, for each new coordinate, an error between the one or more current predicted values for the new coordinate and the one or more new values for the new coordinate in the new input signal and (ii) a differentiable sparsity term that penalizes non-zero updates for the subset of network parameters; and updating the respective updates for each of the subset of network parameters and the distribution parameters using the respective gradients; and generating a compressed representation of the new input signal that identifies the respective updates for the subset of network parameters.

In some implementations, the method includes: storing the compressed representation in association with data identifying the new input signal.

In some implementations, the method includes: transmitting the compressed representation over a data communication network.

In some implementations, determining a respective update for each of a subset of the network parameters further comprises: after the one or more inner iterations: determining, in accordance with the distribution parameters after the one or more inner iterations, a respective final gate value for each network parameter in the subset; for any network parameters in the subset for which the respective final gate value specifies that the respective update for the subset is set to zero, setting a final update for the network parameter to zero; and for any network parameters in the subset for which the respective final gate value specifies that the respective update for the subset is not set to zero, setting a respective final update for the network parameter based on the respective update for the network parameter after the one or more inner iterations.

In some implementations, the subset of network parameters is a proper subset of the network parameters.

In some implementations, a first neural network layer within the neural network has network parameters comprising (i) a weight tensor and (ii) a modulation tensor, and wherein the modulation tensor is in the subset and the weight tensor is not in the subset.

In some implementations, the first neural network layer is configured to perform operations comprising: computing an affine transformation between the weight tensor and a layer input to the layer and applying the modulation tensor to an output of the affine transformation.

In some implementations, the network parameters of the first neural network layer further comprise (iii) a bias tensor, wherein the bias tensor is not in the subset, and wherein applying the modulation tensor to an output of the affine transformation comprises applying the modulation tensor and the bias tensor to the output of the affine transformation.

In some implementations, the subset includes all of the network parameters of the neural network.

In some implementations, the method includes maintaining data specifying shared distribution parameters, and prior to the first of the one or more inner iterations, setting the distribution parameters equal to the shared distribution parameters.

In some implementations, the method includes training the neural network on a plurality of training signals to determine the shared values for the network parameters.

In some implementations, training the neural network on the plurality of training signals comprises: training the neural network to minimize, for a given set of shared values, the inner loss function evaluated after performing a fixed number of inner training steps starting from the given set of shared values for the network parameters.

In some implementations, training the neural network on a plurality of training signals to determine the shared values for the network parameters comprises: training the neural network on the plurality of training signals to determine the shared values for the network parameters and the shared distribution parameters.

In some implementations, training the neural network on the plurality of training signals comprises: training the neural network to minimize, for a given set of shared values and a given set of shared distribution parameters, the inner loss function evaluated after performing a fixed number of inner training steps starting from the given set of shared values for the network parameters and the given set of shared distribution parameters.

In some implementations, determining, in accordance with a set of distribution parameters, a respective gate value for each network parameter in the subset that specifies whether the respective update for the subset is set to zero comprises: sampling noise from a noise distribution; and mapping the set of distribution parameters and the sampled noise to the respective gate values for the network parameters in the subset.

In some implementations, mapping the set of distribution parameters and the sampled noise to the respective gate values for the network parameters in the subset comprises applying a hard rectification to a value determined from the distribution parameters and the sampled noise.

In some implementations, the compressed representation of the new input signal identifies only non-zero updates for network parameters in the subset of network parameters.

In some implementations, each network parameter in the subset has a different respective gate value from each other network parameter in the subset.

In some implementations, two or more network parameters in the subset share a same respective gate value.

In some implementations, the differentiable sparsity term measures a sum of respective probabilities for each respective gate value, wherein the respective probability for each gate value is defined by the distribution parameters and specifies a likelihood that respective updates for one or more network parameters corresponding to the gate value are set to a non-zero value.

In some implementations, the new input signal is an image, wherein each coordinate corresponds to a respective pixel of the image in a two-dimensional coordinate space, and wherein the one or more respective values comprise one or more intensity values of the pixel.

In some implementations, the new input signal is a three-dimensional image, wherein each coordinate corresponds to a respective voxel of the image in a three-dimensional coordinate space, and wherein the one or more respective values comprise one or more intensity values of the voxel.

In some implementations, the new input signal is a point cloud, wherein each coordinate corresponds to a respective point in a three-dimensional coordinate space, and wherein the one or more respective values comprise a respective intensity for the respective point.

In some implementations, the new input signal is a video, wherein each coordinate is a three-dimensional coordinate that identifies a spatial location within a video frame of a pixel from the video, and wherein the one or more respective values comprise one or more intensity values of the pixel.

In some implementations, the new input signal is an audio signal, wherein each coordinate is a respective time point within the audio signal, and wherein the one or more respective values comprise one or more values defining an amplitude of the audio signal at the respective time point.

In some implementations, the new input signal represents a signed distance function, and wherein the one or more respective values comprise a signed distance from a boundary of an object of the corresponding coordinate.

In some implementations, the new input signal represents a rendered scene.

In another aspect, a method includes receiving a request to reconstruct an input data signal; obtaining (i) data specifying shared values for network parameters of a data reconstruction neural network and (ii) data specifying respective updates for a subset of the network parameters that have been determined for the input data signal by training the data reconstruction neural network to reconstruct the input signal while applying a differentiable sparsity term that penalizes updates for the subset of network parameters that are non-zero; and generating a reconstructed input signal, comprising, for each of a plurality of coordinates from a coordinate space of the input data signal: processing an input specifying the coordinate using the data reconstruction neural network in accordance with values of the network parameters that are defined by the shared values and the respective updates to generate one or more values of the reconstructed input signal at the coordinate.

In some implementations, the reconstructed input signal has respective values for more coordinates than the input signal.

In another aspect, this specification one or more computer-readable storage media storing a compressed representation of a new data signal, with the compressed representation of the data signal having been generated by performing operations that include maintaining data specifying shared values for network parameters of a data reconstruction neural network, wherein the data reconstruction neural network is configured to receive an input specifying a coordinate from a coordinate space of an input data signal and to process the input in accordance with the network parameters to generate as output one or more predicted values of the input data signal at the specified coordinate; receiving the new input signal, the new input signal comprising one or more respective new values at each of a plurality of new coordinates; determining a respective update for each of a subset of the network parameters, comprising: at each of one or more inner iterations: determining one or more sets of current values for the network parameters of the data reconstruction neural network, comprising, for each set of current values: determining, in accordance with a set of distribution parameters, a respective gate value for each network parameter in the subset that specifies whether the respective update for the subset is set to zero; determining the set of current values by: for any network parameters not in the subset, setting the current value based on the shared value for the network parameter; for any network parameters in the subset for which the respective gate value specifies that the respective update for the subset is set to zero, setting the current value based on the shared value for the network parameter; and for any network parameters in the subset for which the respective gate value specifies that the respective update for the subset is not set to zero, setting the current value based on the shared value for the network parameter and the respective update for the network parameter; for each of the one or more sets of current values of the network parameters: for each of the new coordinates, processing an input specifying the new coordinate using the data reconstruction neural network and in accordance with the set of current values of the network parameters to generate one or more current predicted values for the new coordinate; determining a respective gradient with respect to each of the respective updates for the network parameters in the subset and the distribution parameters of an inner loss function that, for each set of current values, includes (i) a reconstruction quality term that measures, for each new coordinate, an error between the one or more current predicted values for the new coordinate and the one or more new values for the new coordinate in the new input signal and (ii) a differentiable sparsity term that penalizes non-zero updates for the subset of network parameters; and updating the respective updates for each of the subset of network parameters and the distribution parameters using the respective gradients; and generating the compressed representation of the new input signal that identifies the respective updates for the subset of network parameters.

In another aspect, this specification describes a compressed representation of a data signal, e.g., a bit stream, with the compressed representation of the data signal having been generated by performing operations that include maintaining data specifying shared values for network parameters of a data reconstruction neural network, wherein the data reconstruction neural network is configured to receive an input specifying a coordinate from a coordinate space of an input data signal and to process the input in accordance with the network parameters to generate as output one or more predicted values of the input data signal at the specified coordinate; receiving the new input signal, the new input signal comprising one or more respective new values at each of a plurality of new coordinates; determining a respective update for each of a subset of the network parameters, comprising: at each of one or more inner iterations: determining one or more sets of current values for the network parameters of the data reconstruction neural network, comprising, for each set of current values: determining, in accordance with a set of distribution parameters, a respective gate value for each network parameter in the subset that specifies whether the respective update for the subset is set to zero; determining the set of current values by: for any network parameters not in the subset, setting the current value based on the shared value for the network parameter; for any network parameters in the subset for which the respective gate value specifies that the respective update for the subset is set to zero, setting the current value based on the shared value for the network parameter; and for any network parameters in the subset for which the respective gate value specifies that the respective update for the subset is not set to zero, setting the current value based on the shared value for the network parameter and the respective update for the network parameter; for each of the one or more sets of current values of the network parameters: for each of the new coordinates, processing an input specifying the new coordinate using the data reconstruction neural network and in accordance with the set of current values of the network parameters to generate one or more current predicted values for the new coordinate; determining a respective gradient with respect to each of the respective updates for the network parameters in the subset and the distribution parameters of an inner loss function that, for each set of current values, includes (i) a reconstruction quality term that measures, for each new coordinate, an error between the one or more current predicted values for the new coordinate and the one or more new values for the new coordinate in the new input signal and (ii) a differentiable sparsity term that penalizes non-zero updates for the subset of network parameters; and updating the respective updates for each of the subset of network parameters and the distribution parameters using the respective gradients; and generating the compressed representation of the new input signal that identifies the respective updates for the subset of network parameters.

Particular embodiments of the subject matter described in this specification can be implemented so as to realize one or more of the following advantages.

Some data compression techniques use neural networks that map from a coordinate space to an underlying continuous signal in order to compress the data. These types of approaches are referred to as Implicit Neural Representations (INRs) and have shown that-following careful architecture search-INRs can outperform other, established compression methods for smaller dimensional data or when small compression rates are required.

However, these approaches require transmitting an entire, dense set of network parameters for the neural network (the “data reconstruction neural network”) that maps from coordinates to underlying signal values from the compression system to the decompression system for each data signal to be compressed. Thus, INRs have not been shown to scale to real-world compression scenarios and large-scale, real-world data signals.

This specification describes techniques for significantly increasing the compression rate (and therefore significantly decreasing the compression cost) of INRs while maintaining high reconstruction quality (e.g., low reconstruction error). In particular, this specification describes techniques for drastically reducing the amount of data that needs to be communicated between the compression and decompression systems on a per-signal basis within the INR framework while still maintaining high reconstruction quality. More specifically, this increase in compression rate is achieved by learning per-signal parameter value updates for a subset of the network parameters in a manner that encourages the updates to be sparse, thereby keeping the compression rate high because only these sparse updates need to be communicated to the decompression system. Moreover, the described techniques can be applied to achieve high reconstruction quality on a variety of diverse data modalities such as images, manifolds, signed distance functions, 3D shapes and scenes, and so on.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example compression and decompression system.

FIG. 2 shows an example of compressing and decompressing a new data signal using the data reconstruction neural network.

FIG. 3 is a flow diagram of an example process for compressing a new signal.

FIG. 4 is a flow diagram of an example process for decompressing a new signal.

FIG. 5 is a flow diagram for training the data reconstruction neural network using meta-learning.

FIG. 6 shows an example of the compression results achieved using the described techniques relative to other approaches on three different image data sets.

FIG. 7 shows an example of the compression results achieved using the described techniques relative to another approach on various types of data signals.

FIG. 8 shows example reconstructions of an example image generated by the described techniques.

FIG. 9 shows an example of the compression results achieved using the described techniques when the values of the network parameters are sparse.

Like reference numbers and designations in the various drawings indicate like elements.

### DETAILED DESCRIPTION

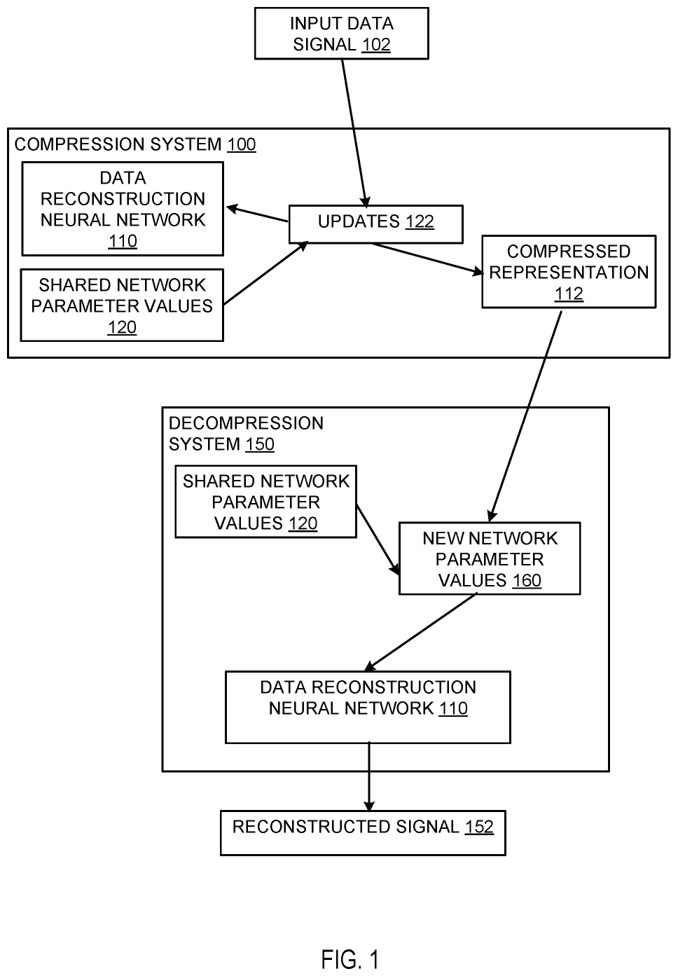

FIG. 1 shows an example compression system 100 and an example decompression system 150.

The systems 100 and 150 are each examples of systems implemented as computer programs on one or more computers in one or more locations, in which the systems, components, and techniques described below can be implemented.

The compression system 100 is a system that compresses an input signal 102 using a data reconstruction neural network 110 to generate a compressed representation 112 of the input signal 102, e.g., a bit stream that encodes the signal-specific information necessary to reconstruct the input signal 102.

The decompression system 100 is a system that decompresses the input signal 102, e.g., generates a reconstruction 152 of the input signal 102, from the compressed representation 112 using the data reconstruction neural network 110.

Generally, the compression and decompression systems 100 and 150 may be co-located or remotely located. That is, the compression system 100 and can be implemented on the same set of one or more computers as the decompression system 150 or can be implemented on a different set of one or more computers in one or more different locations than the decompression system 150.

Compressed representations generated by the compression system 100 can be provided to the decompression system 150 in any of a variety of ways.

For example, the compressed data may be stored (e.g., in a physical data storage device or logical data storage area) in association with data identifying the corresponding input signal, and then subsequently retrieved from storage and provided to the decompression system 150.

As another example, the compressed data may be transmitted over a communications network (e.g., the Internet) to a destination, where it is subsequently retrieved and provided to the decompression system 150.

The input signal 102 is a data signal that has one or more respective values for each of a plurality of coordinates in a coordinate space.

For example, the input signal can be an image that has a respective intensity value for each of one or more channels for each of a plurality of pixels in a two-dimensional coordinate space, e.g. a two-dimensional grid. Thus, each coordinate corresponds to a respective pixel of the image in the two-dimensional coordinate space and the one or more respective values are one or more intensity values of the pixel. For example, for an RGB image, the one or more respective values can include the R, G, and B values for the pixel.

As another example, the input signal can be a three-dimensional image, where each coordinate corresponds to a respective voxel of the image in a three-dimensional coordinate space, e.g., a three-dimensional grid, where the one or more respective values are one or more intensity values of the voxel. Examples of such images include computer tomography (CT) image, a magnetic resonance imaging (MRI) image, an ultrasound image, an X-ray image, a mammogram image, a fluoroscopy image, or a positron-emission tomography (PET) image.

As another example, the input signal can be a point cloud, each coordinate can correspond to a respective point in a three-dimensional coordinate space, and the one or more respective values can include a respective intensity for the respective point. The values can optionally include other components of a point in a point cloud, e.g., return, second return, elongation, and so on. For example, the input signal can be a point cloud captured by a laser sensor, e.g., a LiDAR sensor.

As another example, the input signal can be a video, where each coordinate is a three-dimensional coordinate that identifies a spatial location within a video frame of a pixel from the video, e.g., the x, y, t coordinates of the pixel, and the one or more respective values are one or more intensity values of the pixel.

As another example, the input signal can be an audio signal, where each coordinate is a respective time point within the audio signal and the one or more respective values include one or more values defining an amplitude of the audio signal at the respective time point, e.g., a raw amplitude value, a compressed amplitude value, a companded amplitude value, or a compressed and companded amplitude value.

As can be seen from the above examples, the input signal can be any appropriate signal sensed by one or more sensors, e.g., one or more sensors configured to sense a real-world environment.

As another example, the input signal can represent a signed distance function, e.g., of an object or a set of one or more objects, and wherein the one or more respective values comprise a signed distance from a boundary of an object (or set of objects) of the corresponding coordinate.

As another example, the input signal can represent a rendered scene, e.g., a 3-D rendered scene, where the coordinates represent points in a coordinate space of the scene, e.g., a three-dimensional coordinate system, and the respective values can include a density value and one or more color values of the scene at the point. The 3-D rendered scene may be a 3-D scene that has been rendered based upon one or more 2-D images, e.g. one or more 2-D images captured by a camera. That is, the input signal can represent the information necessary to generate 2-D images of the 3-D rendered scene from arbitrary, new viewpoints that are different from the 2-D images captured by the camera. In other words, the input signal can represent the scene in a Neural Radiance Field (NeRF) framework.

The data reconstruction neural network 110 is a neural network that is configured to receive an input specifying a coordinate from a coordinate space of an input data signal and to process the input in accordance with the network parameters to generate as output one or more predicted values of the input data signal at the specified coordinate, i.e., predictions of the one or more values of the input data signal at the specified coordinate. Thus, the neural network 110 can be used to generate or reconstruct a data signal, by for each coordinate of the data signal, providing the coordinate as input to the neural network 110 to obtain as output one or more predicted values of the data signal at the coordinate.

The data reconstruction neural network 110 can generally have any appropriate architecture that allows the neural network 110 to map an input that specifies a coordinate to one or more predicted values for the coordinate.

As one example, the neural network 110 can be a Multi-Layer Perceptron (MLP). Optionally, the MLP can be augmented with either positional encodings, sinusoidal activation functions, or both.

In order to compress and decompress data signals using the neural network 110, the compression system 100 and the decompression system 150 each maintain data specifying shared values 120 for the network parameters of the data reconstruction neural network 110.

These values are referred to as “shared” values because they have been determined prior to receiving any given data item that is to be compressed and are then used as part of the compression and decompression process for each subsequent data signal.

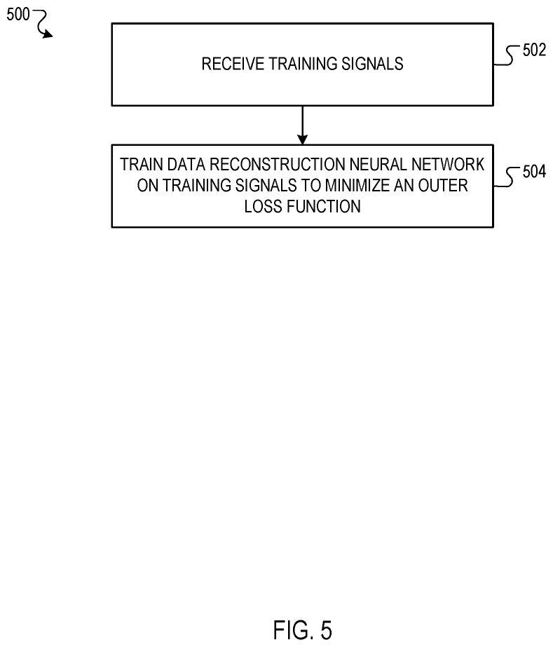

For example, the shared values 120 can be determined by training the data reconstruction neural network 110 on a set of training data that includes multiple different data signals, e.g., through meta learning. An example of training the data reconstruction neural network 110 is described in more detail below with reference to FIG. 5.

When a new input signal 102 that includes one or more respective values (“new values”) at each of a plurality of coordinates (“new coordinates”) in the coordinate space.is received by the system 100, the system 100 determines a respective update 122 for each of a subset of the network parameters.

In some implementations, the subset includes all of the network parameters.

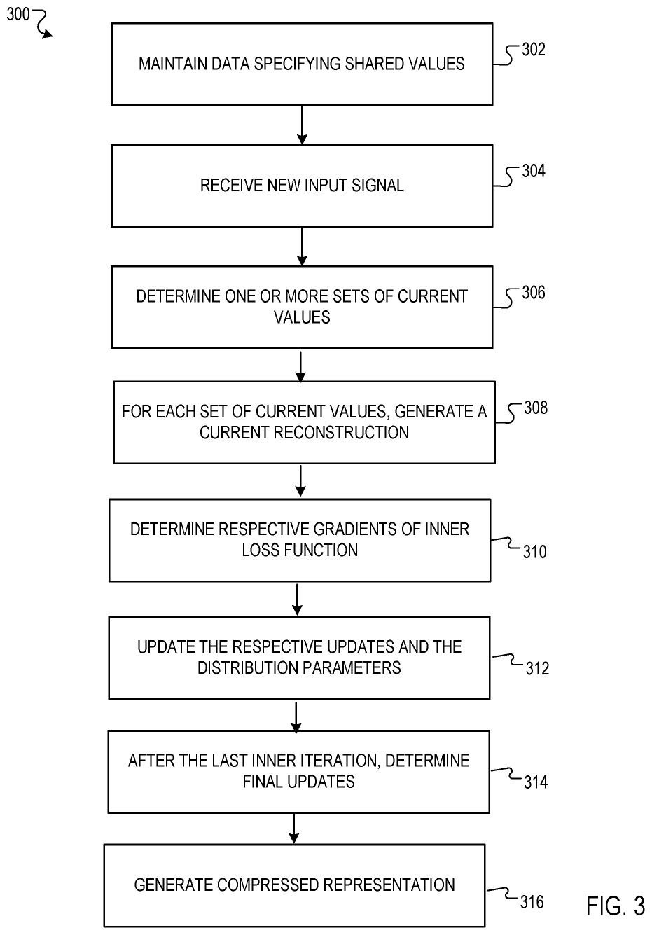

In some other implementations, the subset is a proper subset and includes less than all of the network parameters. These implementations will be described in more detail below with reference to FIG. 3.

At a high level, the system 100 generates the updates 122 in a manner that causes the reconstruction neural network 110 to generate more accurate reconstructions of the new input signal 102 while encouraging the updates 122 to be sparse, i.e., encouraging the updates 122 for a large fraction of the network parameters in the subset to be zero.

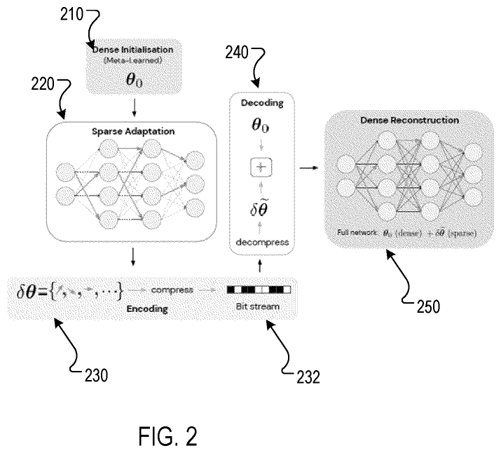

Determining the updates 122 for the subset of network parameters is described in more detail below with reference to FIGS. 2 and 3.

After generating the updates 122, the system 100 generates a compressed representation 112 of the new input signal 102 that identifies the respective updates 122 for the subset of network parameters. Because of the way in which the system 100 determines the respective updates 122, many of the updates 122 will be zero, and the compressed representation 112 needs to only identify which parameters have updates that are non-zero and the respective updates 122 for the identified parameters. This drastically reduces compression cost while maintaining a high quality compression.

For example, the system 100 can apply a compression technique to the data identifying which parameters have updates that are non-zero and the respective updates 122 for the identified parameters to generate the compressed representation 112. The compression technique can be any appropriate technique, e.g., entropy coding techniques, e.g., arithmetic coding or Huffman coding, or learned deep entropy coding techniques, or another appropriate technique.

As a particular example, the system 100 can apply a quantization scheme, e.g., a uniform quantization scheme, to the non-zero updates to generate quantized updates and then entropy code the quantized updates to generate the compressed representation 112.

It will be appreciated that, as the compressed representation needs to only identify updates 122 for parameters that are non-zero, the amount of data needed to encode the updates 122 is already (i.e. without further compression) significantly reduced in comparison to data needed to represent updates to all parameters. As such, in an alternative example, the compressed representation 112 may represent the updates 122 without applying further compression techniques. That is, the updates 122 and the compressed representation 112 may be identical.

Once generated, the system 100 can store the compressed representation 112 in association with data identifying the new signal 102 for later use or can send the compressed representation 112 over a data communication network.

When the decompression system 150 receives a request to reconstruct an input signal 102, the system 150 obtains data specifying the respective updates 122 for the subset of the network parameters that have been determined for the input signal 102.

In particular, the system 150 can decompress the compressed representation 112 using the decompression technique that corresponds to the compression technique that was used to generate the compressed representation 112 to determine the respective updates 122.

The system 150 then generates the reconstructed input signal 152 using the shared values 120 and the respective updates 122. Where no further compression was applied to the updates 122, the system 150 may simply receive the updates 122.

In particular, the system 150 can determine new values 160 of the network parameters that are defined by the shared values 120 and the respective updates 122, e.g., by, for each network parameter that has a non-zero update 122, combining the update 122 and the shared value 120 for the network parameter to determine the new value 160 for the network parameter. The system 150 can determine the new value 160 for a given network parameter, e.g., by adding the update 122 and the shared value 120 or by subtracting the update 122 from the shared value 120.

To generate the reconstructed input signal 152, the system 150 processes, for each of a plurality of coordinates from the coordinate space of the input data signal 102, an input specifying the coordinate using the data reconstruction neural network 110 in accordance with the new values 160 to generate a value of the reconstructed input signal 152 at the coordinate.

In some implementations, the decompression system 150 generates a “faithful” reconstruction that includes reconstructed values for each of the coordinates of the input signal 102.

In some other implementations, the decompression system 150 can generate a higher-resolution reconstruction that has respective values for more coordinates than the input signal 102. That is, the system 150 can perform super-resolution or in-filling to increase the resolution of the input signal 102 as part of generating the reconstruction

FIG. 2 shows an example of compressing and decompressing a new data signal using the data reconstruction neural network 110.

As shown in FIG. 2, the compression of a new data signal starts with dense initialized values 210 of the network parameters of the data reconstruction neural network 110, also referred to as “shared values” of the parameters in this specification.

These dense initialized values are referred to as dense because there has been no constraint imposed upon the values to encourage significant proportions of the values to be zero. As a particular example, these values can have been determined by training the data reconstruction neural network 110 through meta learning. An example of this will be described in more detail below with reference to FIG. 5.

The compression system 100 then performs sparse adaptation 220 to determine sparse updates for a subset of the network parameters. The adaptation 220 generates updates for the dense initialized values 210 of the network parameters. The adaptation 220 is referred to as “sparse” because, during the adaptation, the system 100 is penalized for parameters in the subset having non-zero updates. Thus, as a result, the adaptation 220 generally terminates with a large number of the parameters in the subset having updates that are set to zero.

Performing this sparse adaptation 220 to determine the respective updates is described in more detail below with reference to FIG. 3.

The compression system 100 then performs encoding 230 to generate a compressed representation, e.g., a bitstream 232, of the new data signal. The compressed representation contains sufficient information for the decompression system 150 to accurately reconstruct the new data signal.

In particular, because the dense initialized values 210 are shared for all data signals and because the decompression system 150 also maintains the values 210 and an instance of the reconstruction neural network 110, the only information required by the decompression system 150 to reconstruct the data signal are the updates determined by the sparse adaptation 220 by performing the adaptation 220.

Thus, the compression system 100 performs the encoding by applying a compression technique to the updates to generate a bit stream 232 that can be decoded by the decompression system 150. Because the adaptation 220 is “sparse,” only a small portion of the updates are non-zero and need to be encoded in the bit stream 232, further increasing the compression rate of the compression performed by the system 100.

To reconstruct the data signal, the decompression system 150 performs decoding 240 by decompressing the bit stream 232 to recover the updates and then combining the updates and the dense initialized values 210 (the shared values) to generate new values of the network parameters.

The system 150 then performs dense reconstruction 250 in accordance with the new values. Although the reconstruction is dense, thereby allowing for high reconstruction quality, the denseness is afforded by the dense initialized values 210 (the shared values) that do not impact per-signal compression cost. Thus, the only signal-specific information are the signal-specific updates, which are sparse, thereby allowing for high compression rate.

FIG. 3 is a flow diagram of an example process 300 for compressing a new data signal. For convenience, the process 300 will be described as being performed by a system of one or more computers located in one or more locations. For example, a compression system, e.g., the compression system 100 of FIG. 1, appropriately programmed, can perform the process 300.

The system maintains data specifying the shared values for the network parameters of the data reconstruction neural network (step 302).

The system then receives a new input signal (step 304) that includes one or more respective values (“new values”) at each of a plurality of coordinates (“new coordinates”) in the coordinate space.

As described above, the system determines a respective update for each of a subset of the network parameters.

In some implementations, the subset includes all of the network parameters.

In some other implementations, the subset is a proper subset and includes less than all of the network parameters.

As a particular example of this, one or more of the layers in the neural network can have network parameters that include (i) a weight tensor and (ii) a modulation tensor, with the modulation tensor being in the subset and the weight tensor not being in the subset.

For example, when processing an input, a layer having this architecture can be configured to perform operations that include computing an affine transformation between the weight tensor and a layer input to the layer and applying the modulation tensor to an output of the affine transformation. For example, the affine transformation can be a matrix-matrix or matrix-vector multiplication or a convolution. The layer can apply the modulation factor by adding the modulation tensor to the output of the affine transformation

Optionally, the layer(s) having this architecture can also have a bias tensor that is also not in the subset and applying the modulation tensor to an output of the affine transformation can include applying the modulation tensor and the bias tensor to the output of the affine transformation. For example, the layer can add both the modulation tensor and the bias tensor to the output of the affine transformation.

Thus, the layer(s) having this architecture can adapt to each new input signal by modifying only a small subset of their parameters, decreasing the compression cost of the compression because parameters not in the subset cannot be updated and therefore do not need to be represented in the compressed representation.

To determine the updates for the network parameters, the system performs one or more inner optimization iterations (“inner iterations”). At each inner iteration, the system optimizes an inner loss function that both encourages the updates to improve reconstruction quality and to be sparse among the network parameters in the subset.

In particular, at each inner iteration, the system determines one or more sets of current values for the network parameters (step 306).

To generate a given set of current values at a given inner iteration, the system determines, in accordance with a set of distribution parameters, a respective gate value for each network parameter in the subset that specifies whether the respective update for the subset is set to zero.

For example, the distribution parameters can be the parameters of a continuous distribution that assigns a respective probability to each gate. For example, the continuous distribution can be a Hard concrete distribution or any other continuous distribution that allows for the reparameterization trick. The system can use a suitable estimator to sample from the continuous distribution at test time.

For the first inner iteration, the parameters can be shared distribution parameters that are common across all new data signals. That is, the system can maintain data specifying shared distribution parameters and, prior to the first of the one or more inner iterations, set the distribution parameters equal to the shared distribution parameters.

As one example, these shared distribution parameters can be pre-determined and fixed for all data signals.

As another example, the shared distribution parameters can be learned jointly with the shared values of the network parameters, e.g., during the training of the data reconstruction neural network through meta learning. That is, as part of the meta-learning, the system effectively learns an initial, sparse update configuration that has been determined to work well for the training data signals that the system uses for the meta-learning.

For any subsequent inner iterations, the distribution parameters can be the distribution parameters after being updated at the preceding inner iteration.

In this example, the system can determine the respective gate values using the reparameterization trick, i.e., by sampling noise from a noise distribution and then performing a deterministic mapping from the distribution parameters and the noise to a respective probability for each gate, and then performing a hard rectification to map each gate to a zero (indicating that the update is set to zero) or a one (indicating that the update is not set to zero). Performing a hard rectification refers to mapping a value s sampled from a distribution (or determined using the deterministic mapping) to a zero or a one by applying a function g as follows: g(s)=min(1, max(0, s)).

The system then determines the set of current values.

In particular, for any network parameters not in the subset, the system sets the current value based on the shared value for the network parameter, e.g., equal to the shared value for the network parameter.

For any network parameters in the subset for which the respective gate value specifies that the respective update for the subset is set to zero, the system sets the current value based on the shared value for the network parameter, e.g., equal to the shared value.

For any network parameters in the subset for which the respective gate value specifies that the respective update for the subset is not set to zero, the system sets the current value based on the shared value for the network parameter and the respective update for the network parameter, e.g., equal to a sum or a difference of the shared value for the network parameter and the respective update as of the inner iteration, or equal to a sum or a difference of the shared value for the network parameter and a moving average of the respective updates as of the inner iteration any and inner iteration preceding the inner iteration.

In some implementations, each network parameter in the subset has a different respective gate value from each other network parameter in the subset, i.e., the distribution parameters assign a respective probability to a separate gate value for each of the network parameters.

In some other implementations, two or more network parameters in the subset share the same respective gate value. That is, the system imposes a sparsity pattern on the updates by requiring that certain network parameters in the subset be jointly set to zero or be jointly updated.

When multiple sets of current values are generated, the system can independently sample the noise for each set of current values, i.e., so that different sets of current values can assign the updates for different ones of the network parameters in the subset to zero.

For each of the one or more sets of current values of the network parameters, the system generates a current reconstruction of the new input signal using the set of current values of the network parameters (step 308). That is, for each set of current values and for each of the new coordinates, the system processes an input specifying the new coordinate using the data compression neural network and in accordance with the set of current values of the network parameters to generate a current predicted value for the new coordinate.

At each inner iteration, the system determines a respective gradient with respect to each of the respective updates for the network parameters in the subset and the distribution parameters of the inner loss function (step 310).

In particular, the inner loss function includes, for each set of current values, (i) a reconstruction quality term that measures, for each new coordinate, an error between the one or more current predicted values for the new coordinate and the one or more new values for the new coordinate in the new input signal and (ii) a differentiable sparsity term that penalizes non-zero updates for the subset of network parameters. For example, the inner loss function can be a sum or a weighted sum of the reconstruction quality term and the differentiable sparsity term. Thus, as described above, the inner loss function both encourages increased reconstruction quality and encourages the updates to be sparse.

As one example, the reconstruction term can be a squared error term that measures the sum or the mean of, for each new coordinate, the square of the error, e.g., the L2 distance, between a vector of the one or more current predicted values for the new coordinate and a vector of the one or more new values for the new coordinate.

The system can use any of a variety of differentiable sparsity terms that penalize non-zero updates, i.e., that are larger when the expected number of non-zero updates given the current distribution parameters is greater.

As one example, the differentiable sparsity term can measure a sum of respective probabilities for each respective gate value.

As indicated above, the respective probability for each gate value is defined by the distribution parameters and specifies the likelihood that respective updates for one or more network parameters corresponding to the gate value are set to a non-zero value.

For example, the probability for a given gate value can be expressed using the cumulative density function (CDF) of the continuous probability distribution, e.g., as one minus the probability of the value s being less than or equal to zero according to the CDF given the current distribution parameters.

The system then updates the respective updates for each of the subset of network parameters and the distribution parameters using the respective gradients, e.g., by applying an optimizer to the gradients (step 312).

After the last inner iteration, the system determines the respective (final) updates for the subset of network parameters (step 314).

In particular, after the last inner iteration, the system determines, in accordance with the distribution parameters after the last inner iterations, a respective final gate value for each network parameter in the subset as described above.

For any network parameters in the subset for which the respective final gate value specifies that the respective update for the subset is set to zero, the system sets the final update for the network parameter to zero.

For any network parameters in the subset for which the respective final gate value specifies that the respective update for the subset is not set to zero, the system sets the respective final update for the network parameter based on the respective update for the network parameter after the last inner iteration. For example, the system can set the final update for the network parameter to be equal to the respective update for the network parameter after the last inner iteration or set the final update for the network parameter to be equal to a moving average of the respective updates after each of the one or more inner iterations.

The system then generates a compressed representation of the new input signal that identifies the respective updates for the subset of network parameters (step 316).

Because of the differentiable sparsity term, many of the updates will be zero, and the compressed representation needs to only identify which parameters have updates that are non-zero and the respective updates for the identified parameters. This drastically reduces compression cost while maintaining a high quality compression.

For example, as described above, the system can apply a compression technique to the data that identifies which parameters have updates that are non-zero and the respective updates for the identified parameters to generate the compressed representation.

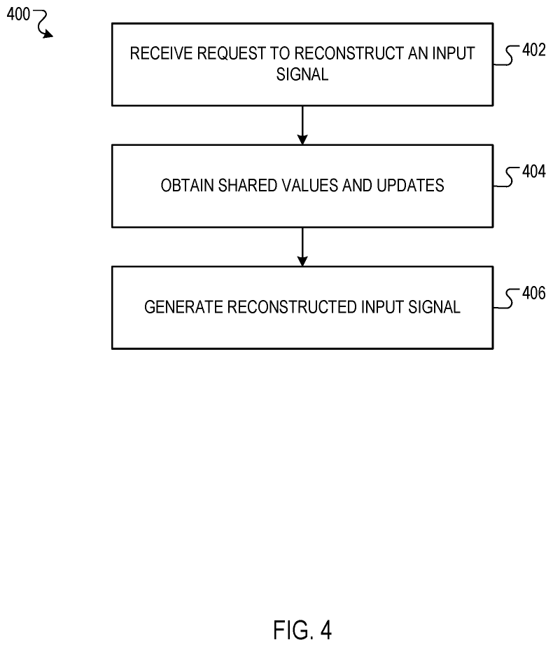

FIG. 4 is a flow diagram of an example process 400 for generating a reconstruction of a new data signal. For convenience, the process 400 will be described as being performed by a system of one or more computers located in one or more locations. For example, a decompression system, e.g., the decompression system 150 of FIG. 1, appropriately programmed, can perform the process 400.

The system receives a request to reconstruct an input data signal (step 402).

The system obtains (i) data specifying shared values for network parameters of the data reconstruction neural network and (ii) data specifying respective updates for a subset of the network parameters that have been determined for the input data signal (step 404).

For example, the data specifying the shared values for the network parameters can be maintained by the system and used when reconstructing all data signals.

The data specifying the respective updates for the subset of network parameters can have been determined by a compression system by training the data reconstruction neural network to reconstruct the input signal while applying a differentiable sparsity term that penalizes updates for the subset of network parameters that are non-zero, i.e., by training the data reconstruction neural network on the inner loss function that is described above.

The system generates a reconstructed input signal (step 406).

In particular, for each of a plurality of coordinates from the coordinate space of the input data signal, the system processes an input specifying the coordinate using the data reconstruction neural network in accordance with values of the network parameters that are defined by the shared values and the respective updates to generate one or more values of the reconstructed input signal at the coordinate.

Thus, the reconstructed input signal includes, for each of the plurality of coordinates, the one or more respective values that were generated by the data reconstruction neural network for the coordinate.

FIG. 5 is a flow diagram of an example process 500 for training the data reconstruction neural network through meta-learning to obtain the shared values of the network parameters. For convenience, the process 400 will be described as being performed by a system of one or more computers located in one or more locations. For example, a compression system, e.g., the compression system 100 of FIG. 1, a decompression system, e.g., the decompression system 150 of FIG. 1, or a different training system, appropriately programmed, can perform the process 500.

The system obtains a plurality of training signals (step 502).

The system training the data reconstruction neural network on the plurality of training signals to determine the shared values for the network parameters (step 504). Optionally, the system also jointly learns the shared values of the distribution parameters, i.e., so that, the system trains the neural network on the plurality of training signals to determine the shared values for the network parameters and the shared distribution parameters.

In particular, the system trains the neural network to minimize an outer loss function.

The outer loss function measures, for a given set of shared values and for a given training signal, a value of the inner loss function evaluated after performing a fixed number of inner training steps for the given training signal starting from the given set of shared values for the network parameters.

When the system is also determining the shared distribution parameters, the outer loss function measures, for a given set of shared values and a given set of shared distribution parameters and for a given training signal, a value of the inner loss function evaluated after performing a fixed number of inner training steps for the training signal starting from the given set of shared values for the network parameters and the given set of shared distribution parameters.

The system can use any of a variety of meta-learning techniques to minimize the outer loss function. For example, the system can use a Model-agnostic Meta Learning (MAML) technique, e.g., one that updates the shared values of the network parameters and, optionally, the shared distribution parameters by directly optimizing the second-order objective by differentiating through the learning process or by using a first-order approximation of this optimization.

Because of the sparsity encouraged by the differentiable sparsity term in the inner loss function, the computational cost of minimizing the outer loss function is decreased relative to meta-learning approaches that do not employ a sparsity term in the inner loss, e.g., as a result of the computational savings achieved when the gradients of the inner loss function are zero with respect to a large number of the network parameters due to the imposed sparsity.

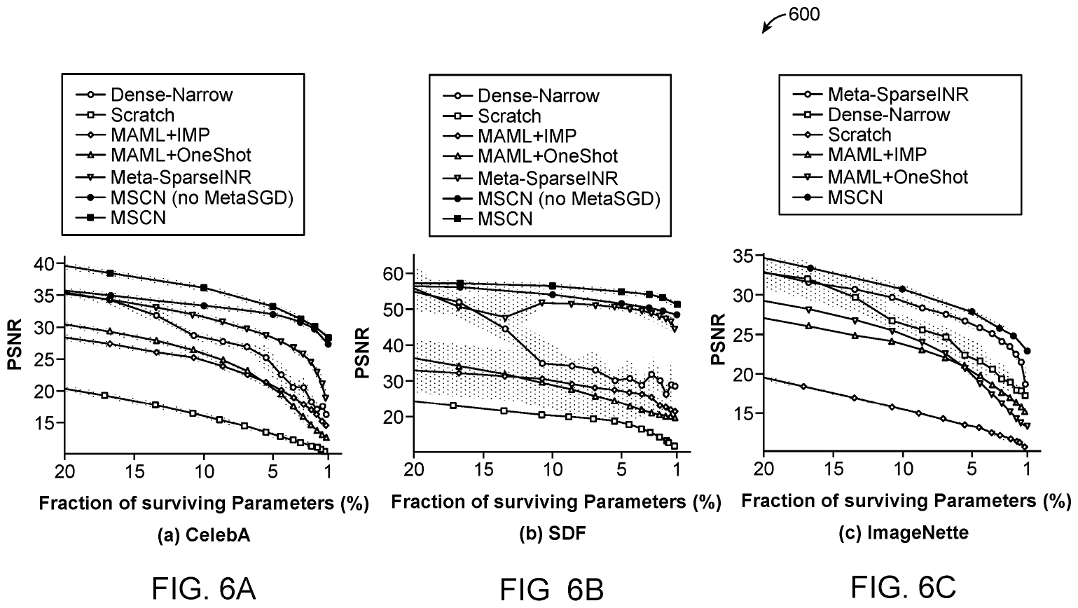

FIG. 6 shows an example 600 of the compression results achieved using the described techniques (MSCN) relative to other approaches on three different image data sets, CelebA, SDF, and ImageNette. The results are shown in terms of Peak signal-to-noise ratio (PSNR), a metric commonly used to quantify reconstruction quality. As can be seen from FIG. 6, at a given compression rate (% of surviving parameters, i.e., parameters that have non-zero updates), the described techniques generally result in higher quality reconstructions than the other approaches.

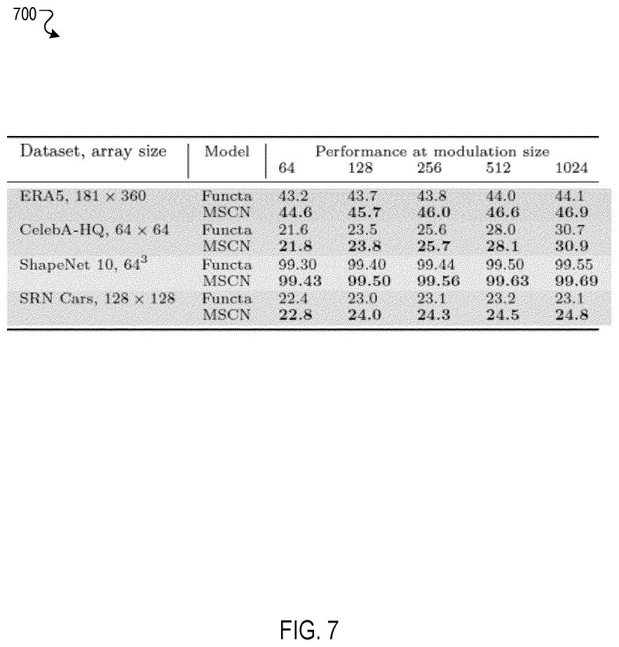

FIG. 7 shows an example 700 of the compression results achieved using the described techniques (MSCN) relative to another approach (Functa) on various types of data signals: CelebA (images), ERA5 (manifolds), ShapeNet (voxel grids), and SRN Cars (rendered 3D scenes). In the example of FIG. 7, the subset of network parameters is a proper subset and does not include all of the parameters of the neural network-different columns of FIG. 7 correspond to different sizes of the proper subset. As can be seen from FIG. 7, at a given size of the subset, the described techniques generally result in higher quality reconstructions than the other approach across the variety of types of data signals.

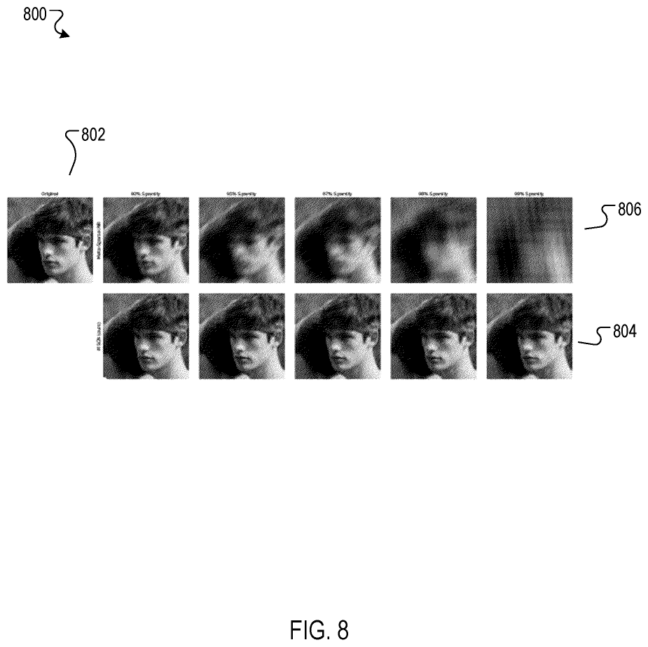

FIG. 8 shows example reconstructions 800 of an example image 802 generated by the described techniques. In particular, FIG. 8 shows example reconstructions 804 generated using the described techniques at various sparsity rates, i.e., with the update for different fractions of the network parameters in the subset being set to zero, relative to reconstructions 806 generated using an existing technique, Meta-Sparse-INR, at the same sparsity rates. In particular, the FIG. 8 shows reconstructions 804 and 806 at (from left to right) 90% sparsity, 95% sparsity, 97% sparsity, 98% sparsity, and 99% sparsity. As can be seen from FIG. 8, the described techniques consistently provide improved reconstruction quality across all sparsity rates and, even with 99% sparsity, are able to provide a coherent reconstruction of the original image 802.

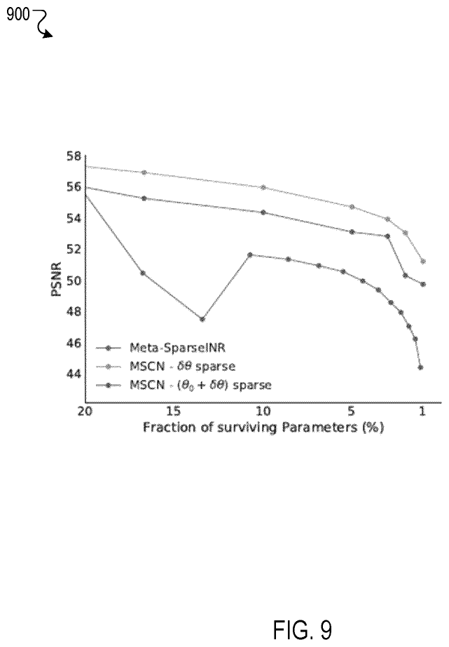

FIG. 9 shows an example 900 of the compression results achieved using the described techniques when the values of the network parameters are sparse. That is, as described above, the system does not impose any sparsity constraints on the shared values of the network parameters. Thus, the current values of the network parameters used at any given inner iteration and the new values of the network parameters used by the decompression system to reconstruct data signals are likely to be dense, i.e., to not have a significant number of zero values. However, there may be applications where a sparse final network, i.e., a neural network that has a significant number of parameters that have zero values, is desirable (e.g., for fast forward passes at inference time when performing the inner iterations or reconstructing the data signal).

In these cases, the system can apply the gate values to the sum of the shared value and the update during the inner iterations, i.e., so that rather than only the updates being sparse, the current values of the network parameters are sparse. That is, for parameters in the subset, if the gate value indicates that the value of the network parameter should be set to zero, the system sets the new value (instead of just the update) of the parameter to zero. Thus, the system achieves sparse current values for the network parameters in the subset instead of sparse updates.

In the example of FIG. 9, the PSNR of three different approaches on the SDF data set is shown: an existing Meta-Sparse INR technique, the approach described above (MSCN-δθ sparse) with sparse updates, and the approach described above with sparse current values (MSCN−(θ₀+δθ)). As can be seen from the example of FIG. 9, while the approach with sparse updates improves over both alternatives at each fraction of surviving parameters, the approach with sparse current values nonetheless consistently improves over the existing technique. Note that, for the (MSCN−(θ₀+δθ)) technique, a surviving parameter means that the parameter has a non-zero value, rather than only the update for the parameter being sparse. Thus, by having current values for a large number of the network parameters in the subset be zero, the (MSCN−(θ₀+δθ)) technique can result in reduced inference time and inference cost due to the large number of zero-valued parameters in the neural network.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method performed by one or more computers, the method comprising:
maintaining data specifying shared values for network parameters of a data reconstruction neural network, wherein the data reconstruction neural network is configured to receive an input specifying a coordinate from a coordinate space of an input data signal and to process the input in accordance with the network parameters to generate as output one or more predicted values of the input data signal at the specified coordinate;
receiving a new input signal comprising one or more respective new values at each of a plurality of new coordinates;
determining a respective update for each of a subset of the network parameters, comprising:
at each of one or more inner iterations:
determining one or more sets of current values for the network parameters of the data reconstruction neural network, comprising, for each set of current values:
determining, in accordance with a set of distribution parameters, a respective gate value for each network parameter in the subset that specifies whether the respective update for the subset is set to zero;
determining the set of current values by:
for any network parameters not in the subset, setting the current value based on the shared value for the network parameter;
for any network parameters in the subset for which the respective gate value specifies that the respective update for the subset is set to zero, setting the current value based on the shared value for the network parameter; and
for any network parameters in the subset for which the respective gate value specifies that the respective update for the subset is not set to zero, setting the current value based on the shared value for the network parameter and the respective update for the network parameter;
for each of the one or more sets of current values of the network parameters:
for each of the new coordinates, processing an input specifying the new coordinate using the data reconstruction neural network and in accordance with the set of current values of the network parameters to generate one or more current predicted values for the new coordinate;
determining a respective gradient with respect to each of the respective updates for the network parameters in the subset and the distribution parameters of an inner loss function that, for each set of current values, includes (i) a reconstruction quality term that measures, for each new coordinate, an error between the one or more current predicted values for the new coordinate and the one or more new values for the new coordinate in the new input signal and (ii) a differentiable sparsity term that penalizes non-zero updates for the subset of network parameters; and
updating the respective updates for each of the subset of network parameters and the distribution parameters using the respective gradients; and
generating a compressed representation of the new input signal that identifies the respective updates for the subset of network parameters.

2. The method of claim 1, further comprising:
storing the compressed representation in association with data identifying the new input signal.

3. The method of claim 1, further comprising:
transmitting the compressed representation over a data communication network.

4. The method of claim 1, wherein determining a respective update for each of a subset of the network parameters further comprises:
after the one or more inner iterations:
determining, in accordance with the distribution parameters after the one or more inner iterations, a respective final gate value for each network parameter in the subset;
for any network parameters in the subset for which the respective final gate value specifies that the respective update for the subset is set to zero, setting a final update for the network parameter to zero; and
for any network parameters in the subset for which the respective final gate value specifies that the respective update for the subset is not set to zero, setting a respective final update for the network parameter based on the respective update for the network parameter after the one or more inner iterations.

5. The method of claim 1, wherein the subset of network parameters is a proper subset of the network parameters.

6. The method of claim 5, wherein a first neural network layer within the neural network has network parameters comprising (i) a weight tensor and (ii) a modulation tensor, and wherein the modulation tensor is in the subset and the weight tensor is not in the subset.

7. The method of claim 6, wherein the first neural network layer is configured to perform operations comprising: computing an affine transformation between the weight tensor and a layer input to the layer and applying the modulation tensor to an output of the affine transformation.

8. The method of claim 7, wherein the network parameters of the first neural network layer further comprise (iii) a bias tensor, wherein the bias tensor is not in the subset, and wherein applying the modulation tensor to an output of the affine transformation comprises applying the modulation tensor and the bias tensor to the output of the affine transformation.

9. The method of claim 1, wherein the subset includes all of the network parameters of the neural network.

10. The method of claim 1, further comprising:
maintaining data specifying shared distribution parameters, and
prior to the first of the one or more inner iterations, setting the distribution parameters equal to the shared distribution parameters.

11. The method of claim 1, further comprising:
training the neural network on a plurality of training signals to determine the shared values for the network parameters.

12. The method of claim 11, wherein training the neural network on the plurality of training signals comprises:
training the neural network to minimize, for a given set of shared values, the inner loss function evaluated after performing a fixed number of inner training steps starting from the given set of shared values for the network parameters.

13. The method of claim 12, further comprising:
maintaining data specifying shared distribution parameters, and
prior to the first of the one or more inner iterations, setting the distribution parameters equal to the shared distribution parameters, and wherein training the neural network on a plurality of training signals to determine the shared values for the network parameters comprises:
training the neural network on the plurality of training signals to determine the shared values for the network parameters and the shared distribution parameters.

14. The method of claim 13, wherein training the neural network on the plurality of training signals comprises:
training the neural network to minimize, for a given set of shared values and a given set of shared distribution parameters, the inner loss function evaluated after performing a fixed number of inner training steps starting from the given set of shared values for the network parameters and the given set of shared distribution parameters.

15. The method of claim 1, wherein determining, in accordance with a set of distribution parameters, a respective gate value for each network parameter in the subset that specifies whether the respective update for the subset is set to zero comprises:
sampling noise from a noise distribution; and
mapping the set of distribution parameters and the sampled noise to the respective gate values for the network parameters in the subset.

16. The method of claim 15, wherein mapping the set of distribution parameters and the sampled noise to the respective gate values for the network parameters in the subset comprises applying a hard rectification to a value determined from the distribution parameters and the sampled noise.

17. The method of claim 1, wherein the compressed representation of the new input signal identifies only non-zero updates for network parameters in the subset of network parameters.

18. The method of claim 1, wherein each network parameter in the subset has a different respective gate value from each other network parameter in the subset.

19. The method of claim 1, wherein two or more network parameters in the subset share a same respective gate value.

20. The method of claim 1, wherein the differentiable sparsity term measures a sum of respective probabilities for each respective gate value, wherein the respective probability for each gate value is defined by the distribution parameters and specifies a likelihood that respective updates for one or more network parameters corresponding to the gate value are set to a non-zero value.

21. The method of claim 1, wherein the new input signal is an image, wherein each coordinate corresponds to a respective pixel of the image in a two-dimensional coordinate space, and wherein the one or more respective values comprise one or more intensity values of the pixel.

22. The method of claim 1, wherein the new input signal is a three-dimensional image, wherein each coordinate corresponds to a respective voxel of the image in a three-dimensional coordinate space, and wherein the one or more respective values comprise one or more intensity values of the voxel.

23. The method of claim 1, wherein the new input signal is a point cloud, wherein each coordinate corresponds to a respective point in a three-dimensional coordinate space, and wherein the one or more respective values comprise a respective intensity for the respective point.

24. The method of claim 1, wherein the new input signal is a video, wherein each coordinate is a three-dimensional coordinate that identifies a spatial location within a video frame of a pixel from the video, and wherein the one or more respective values comprise one or more intensity values of the pixel.

25. The method of claim 1, wherein the new input signal is an audio signal, wherein each coordinate is a respective time point within the audio signal, and wherein the one or more respective values comprise one or more values defining an amplitude of the audio signal at the respective time point.

26. The method of claim 1, wherein the new input signal represents a signed distance function, and wherein the one or more respective values comprise a signed distance from a boundary of an object of the corresponding coordinate.

27. The method of claim 1, wherein the new input signal represents a rendered scene.

28. A method performed by one or more computers, the method comprising:
receiving a request to reconstruct an input data signal;
obtaining (i) data specifying shared values for network parameters of a data reconstruction neural network and (ii) data specifying respective updates for a subset of the network parameters that have been determined for the input data signal by training the data reconstruction neural network to reconstruct the input signal while applying a differentiable sparsity term that penalizes updates for the subset of network parameters that are non-zero; and
generating a reconstructed input signal, comprising, for each of a plurality of coordinates from a coordinate space of the input data signal:
processing an input specifying the coordinate using the data reconstruction neural network in accordance with values of the network parameters that are defined by the shared values and the respective updates to generate one or more values of the reconstructed input signal at the coordinate.

29. The method of claim 28, wherein the reconstructed input signal has respective values for more coordinates than the input signal.

30. A system comprising:
one or more computers; and
one or more storage devices storing instructions that, when executed by the one or more computers, cause the one or more computers to perform operations comprising:
maintaining data specifying shared values for network parameters of a data reconstruction neural network, wherein the data reconstruction neural network is configured to receive an input specifying a coordinate from a coordinate space of an input data signal and to process the input in accordance with the network parameters to generate as output one or more predicted values of the input data signal at the specified coordinate;
receiving a new input signal comprising one or more respective new values at each of a plurality of new coordinates;
determining a respective update for each of a subset of the network parameters, comprising:
at each of one or more inner iterations:
determining one or more sets of current values for the network parameters of the data reconstruction neural network, comprising, for each set of current values:
determining, in accordance with a set of distribution parameters, a respective gate value for each network parameter in the subset that specifies whether the respective update for the subset is set to zero;
determining the set of current values by:
for any network parameters not in the subset, setting the current value based on the shared value for the network parameter;
for any network parameters in the subset for which the respective gate value specifies that the respective update for the subset is set to zero, setting the current value based on the shared value for the network parameter; and
for any network parameters in the subset for which the respective gate value specifies that the respective update for the subset is not set to zero, setting the current value based on the shared value for the network parameter and the respective update for the network parameter;
for each of the one or more sets of current values of the network parameters:
for each of the new coordinates, processing an input specifying the new coordinate using the data reconstruction neural network and in accordance with the set of current values of the network parameters to generate one or more current predicted values for the new coordinate;
determining a respective gradient with respect to each of the respective updates for the network parameters in the subset and the distribution parameters of an inner loss function that, for each set of current values, includes (i) a reconstruction quality term that measures, for each new coordinate, an error between the one or more current predicted values for the new coordinate and the one or more new values for the new coordinate in the new input signal and (ii) a differentiable sparsity term that penalizes non-zero updates for the subset of network parameters; and
updating the respective updates for each of the subset of network parameters and the distribution parameters using the respective gradients; and
generating a compressed representation of the new input signal that identifies the respective updates for the subset of network parameters.

31-33. (canceled)
